(19) United States
(12) Patent Application Publication
(10) Pub. No.: US 2018/0216715 A1
(43) Pub. Date: Aug. 2, 2018

(54) JOINT APPARATUS

(71) Applicant: Nidec-Shimpo Corporation, Nagaokakyo-shi (JP)

(72) Inventors: Kikuo OKAMURA, Nagaokakyo-shi (JP); Hitoshi INOUE, Nagaokakyo-shi (JP)

(21) Appl. No.: 15/822,628

(22) Filed: Nov. 27, 2017

(30) Foreign Application Priority Data
Jan. 31, 2017 (JP) 2017-014937

(51) Int. Cl. F16H 49/00; H02K 7/00; H02K 7/14; B25J 17/00; B25J 9/10; B25J 9/12

(52) U.S. Cl. CPC F16H 49/001; H02K 7/003; H02K 7/14; Y10S 901/23; B25J 9/102; B25J 9/126; B25J 17/00

(57) ABSTRACT

A joint apparatus includes two electric motors. One of the electric motors includes a first hollow shaft arranged to extend in an axial direction of a first central axis; a first rotating portion arranged to rotate around the first hollow shaft; a speed reduction mechanism arranged to reduce a speed of a rotational motion obtained from the first rotating portion; a frame portion arranged to rotate about the first central axis at a rotation rate resulting from the speed reduction by the speed reduction mechanism; and a holder arranged radially outside of the first hollow shaft, and including a cylindrical portion arranged to extend radially outward. The other electric motor includes a second hollow shaft arranged to extend in an axial direction of a second central axis; a second rotating portion arranged to rotate around the second hollow shaft; and a frame portion arranged to rotate around the second hollow shaft along with rotation of the second rotating portion. The cylindrical portion of the holder is fixed to the second hollow shaft.

### CROSS REFERENCE TO RELATED APPLICATIONS

This application claims the benefit of priority to Japanese Patent Application No. 2017-014937 filed on Jan. 31, 2017. The entire contents of this application are hereby incorporated herein by reference.

### BACKGROUND OF THE INVENTION

### 1. Field of the Invention

The present invention relates to a joint apparatus.

### 2. Description of the Related Art

A multi-joint robot described in JP-A 2011-161571, for example, is known as an industrial robot. This multi-joint robot is a welding robot having seven degrees of freedom. The multi-joint robot includes a swivel arranged to be capable of turning about a first rotation axis with respect to a base. A first arm is attached to the swivel such that the first arm is capable of rotating about a second rotation axis included in a plane perpendicular to the first rotation axis. A second arm is attached to an end portion of the first arm such that the second arm is capable of turning about a third rotation axis perpendicular to the second rotation axis. A third arm is attached to an end portion of the second arm such that the third arm is capable of rotating about a fourth rotation axis included in a plane perpendicular to the third rotation axis. A wrist assembly is attached to an end portion of the third arm.

In the multi-joint robot described in JP-A 2011-161571, the arms and drive apparatuses for rotation are alternately connected. Therefore, this multi-joint robot cannot avoid increases in size and weight. In addition, the increase in weight causes greater power to be required for driving of the arms, which leads to a reduction in responsiveness.

In view of the above problems, the present invention has been conceived to provide a joint apparatus which is able to reduce an increase in size and achieve improved responsiveness.

### SUMMARY OF THE INVENTION

A joint apparatus according to a preferred embodiment of the present invention includes a first drive apparatus and a second drive apparatus. The first drive apparatus includes a first hollow shaft arranged to extend in a first axial direction with a first central axis as a center to surround the first central axis; a first rotating portion arranged outside of the first hollow shaft with respect to a first radial direction, and arranged to rotate about the first central axis; a speed reduction mechanism arranged to reduce a speed of a rotational motion obtained from the first rotating portion; a first output portion arranged to rotate about the first central axis at a rotation rate resulting from the speed reduction by the speed reduction mechanism; and a first holder arranged outside of the first hollow shaft with respect to the first radial direction, and including a cylindrical portion arranged to extend outward in the first radial direction. The second drive apparatus includes a second hollow shaft arranged to extend in a second axial direction with a second central axis as a center to surround the second central axis; a second rotating portion arranged outside of the second hollow shaft with respect to a second radial direction, and arranged to rotate about the second central axis; and a second output portion arranged to rotate about the second central axis along with rotation of the second rotating portion. The cylindrical portion of the first holder is fixed to the second hollow shaft.

According to the above preferred embodiment of the present invention, the first and second drive apparatuses together enable two-axis rotational operations. The second drive apparatus is supported by the first drive apparatus through the first holder. Accordingly, the first and second drive apparatuses, which define joint portions, can be arranged in proximity to each other. This leads to limiting an increase in size of the joint apparatus. In addition, the proximity of the joint portions to each other results in a reduction in inertia, which leads to improved responsiveness.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a sectional view of a robot arm system according to a preferred embodiment of the present invention.

FIG. 2 is a sectional view of a first joint apparatus according to a preferred embodiment of the present invention.

FIG. 3 is a sectional view of the first joint apparatus taken along line III-III in FIG. 2.

FIG. 4 is a perspective view of a holder according to a preferred embodiment of the present invention.

FIG. 5 is a perspective view of a holder according to a preferred embodiment of the present invention.

FIG. 6 is a sectional view of a second joint apparatus according to a preferred embodiment of the present invention.

FIG. 7 is a perspective view of a holder according to a preferred embodiment of the present invention.

### DETAILED DESCRIPTION OF THE PREFERRED EMBODIMENTS

Hereinafter, preferred embodiments of the present invention will be described with reference to the accompanying drawings. It is assumed herein that a direction parallel to a central axis of an electric motor is referred to by the term “axial direction”, “axial”, or “axially”, that directions perpendicular to the central axis of the electric motor are each referred to by the term “radial direction”, “radial”, or “radially”, and that a direction along a circular arc centered on the central axis of the electric motor is referred to by the term “circumferential direction”, “circumferential”, or “circumferentially”.

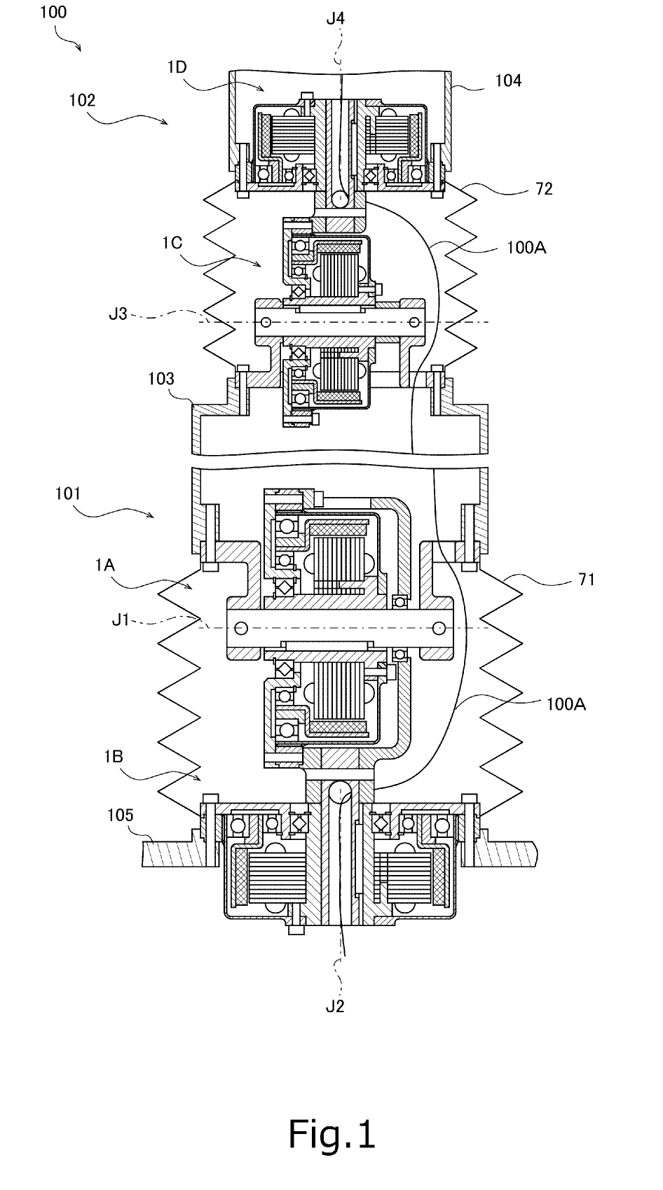

FIG. 1 is a sectional view of a robot arm system 100 according to a preferred embodiment of the present invention.

The robot arm system 100 includes a first joint apparatus 101, a second joint apparatus 102, a first arm 103, a second arm 104, and a base 105. The robot arm system 100 is assembled in such a manner that the first joint apparatus 101 is connected to the base 105, the first arm 103 is connected to the first joint apparatus 101, the second joint apparatus 102 is connected to the first arm 103, and the second arm 104 is connected to the second joint apparatus 102. An end effector (not shown) is connected to the second arm 104. The end effector is, for example, a welding torch or a multi-fingered hand to grasp a target object.

The first joint apparatus 101 is fixed to the base 105. The first joint apparatus 101 includes a speed reduction mechanism-equipped electric motor 1A and a speed reduction mechanism-equipped electric motor 1B. Each speed reduction mechanism-equipped electric motor will be hereinafter referred to simply as an “electric motor”. The electric motor 1A is arranged to produce a rotational motion about a first central axis J1. The electric motor 1B is arranged to produce a rotational motion about a second central axis J2 perpendicular to the first central axis J1.

The first arm 103 is supported by the first joint apparatus 101. The first arm 103 is enabled by the first joint apparatus 101 to make joint motions about the first central axis J1 and the second central axis J2.

The second joint apparatus 102 is fixed to the first arm 103. The second joint apparatus 102 includes an electric motor 1C and an electric motor 1D. The electric motor 1C is arranged to produce a rotational motion about a third central axis J3. The electric motor 1D is arranged to produce a rotational motion about a fourth central axis J4 perpendicular to the third central axis J3.

The second arm 104 is supported by the second joint apparatus 102. The second arm 104 is enabled by the second joint apparatus 102 to make joint motions about the third central axis J3 and the fourth central axis J4.

That is, each of the first and second joint apparatuses 101 and 102 according to the present preferred embodiment is capable of making joint motions with two degrees of freedom. Moreover, the robot arm system 100, which includes the first and second joint apparatuses 101 and 102, is capable of making joint motions with four degrees of freedom.

Note that the electric motors of the robot arm system 100 are required to produce greater rotary torque as they are arranged closer to the base 105. Accordingly, the electric motors 1A and 1B of the first joint apparatus 101 are larger than the electric motors 1C and 1D of the second joint apparatus 102 as illustrated in FIG. 1.

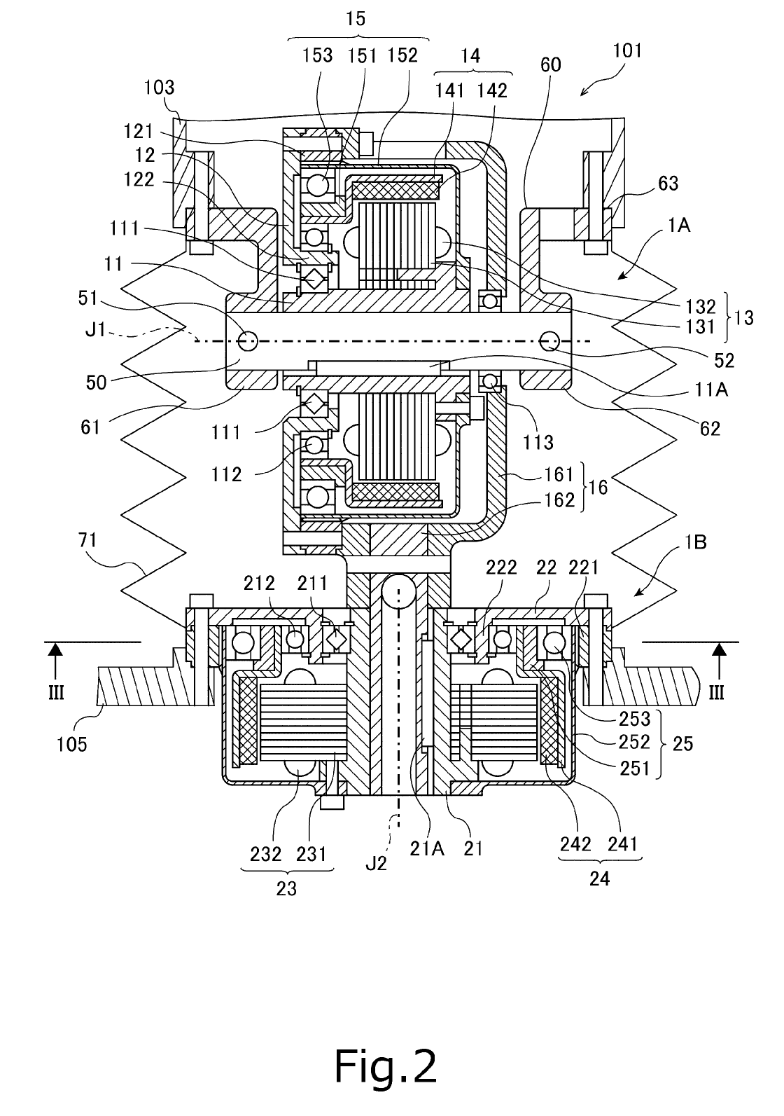

FIG. 2 is a sectional view of the first joint apparatus 101.

The first joint apparatus 101 includes the electric motors 1A and 1B. The electric motor 1A is arranged to support the first arm 103. The electric motor 1B is fixed to the base 105. In addition, the electric motors 1A and 1B are coupled to each other. A junction of the electric motors 1A and 1B is covered with a bellows cover 71 to protect the junction.

### 2.1. Structure of Electric Motor 1B

First, the electric motor 1B will now be described below. The electric motor 1B is an example of a “second drive apparatus” of the present application.

The electric motor 1B includes a hollow shaft 21, a frame portion 22, a stator 23, a rotating portion 24, and a speed reduction mechanism 25.

The hollow shaft 21 is a substantially columnar member arranged to extend along the second central axis J2. A cylindrical portion 162 of a holder 16 of the electric motor 1A is inserted into the hollow shaft 21. The hollow shaft 21 includes a key 21A. Once the cylindrical portion 162 is inserted into the hollow shaft 21, the key 21A is fitted in a key groove 163 of the cylindrical portion 162. As a result, the hollow shaft 21 and the cylindrical portion 162 are fixed to each other such that the hollow shaft 21 and the cylindrical portion 162 are incapable of relative rotation. That is, when the hollow shaft 21 rotates about the second central axis J2, the holder 16 also rotates in a similar manner.

The hollow shaft 21 is an example of a “second hollow shaft” of the present application. The key 21A of the hollow shaft 21 is an example of a “third fastening element” of the present application.

The frame portion 22 is arranged radially outside of the hollow shaft 21. The frame portion 22 is in the shape of a circular ring, and is centered on the second central axis J2. The frame portion 22 is fixed to the base 105 through a connection portion 221, which is arranged at a radially outer end portion of the frame portion 22, using, for example, bolts. The electric motor 1B is thus fixed to the base 105. In addition, the frame portion 22 includes a tubular portion 222 at a radially inner end portion thereof. The tubular portion 222 is arranged to extend in an axial direction with the second central axis J2 as a center. The tubular portion 222 is arranged to surround the hollow shaft 21 with a space therebetween.

A bearing 211 is arranged between an inner circumferential surface of the tubular portion 222 and an outer circumferential surface of the hollow shaft 21. The bearing 211 is a cross-roller bearing, and is arranged to rotatably connect the hollow shaft 21 and the frame portion 22 to each other. Use of the cross-roller bearing as the bearing 211 allows the hollow shaft 21 and the frame portion 22 to be connected to each other with high strength.

The stator 23 is arranged radially outside of the hollow shaft 21. The stator 23 is arranged to produce a torque to rotate the rotating portion 24, which will be described below. The stator 23 includes a stator core 231 and a plurality of coils 232. The stator core 231 is a laminated structure defined by laminated magnetic bodies each of which is in the shape of a circular ring and is centered on the second central axis J2. The stator core 231 is fixed to the outer circumferential surface of the hollow shaft 21. The stator core 231 includes a plurality of teeth arranged to project radially outward. The coils 232 are wound around the teeth, and are arranged in an annular shape with the second central axis J2 as a center. The coils 232 are made up of three coil groups. The three coil groups are a coil group for a U phase, a coil group for a V phase, and a coil group for a W phase. Each coil group is defined by one conducting wire.

The rotating portion 24 is arranged radially outside of the stator 23 with respect to the second central axis J2. The rotating portion 24 includes a rotor hub 241 and a rotor magnet 242. The rotor hub 241 is cylindrical. The rotor hub 241 is arranged radially outside of the stator 23 and the tubular portion 222 of the frame portion 22 with respect to the second central axis J2. The rotor magnet 242 is fixed to an inner circumferential surface of the rotor hub 241. The rotor magnet 242 is arranged opposite to the stator 23, which is arranged radially inside of the rotor magnet 242 with respect to the second central axis J2, with a gap therebetween.

A bearing 212 is arranged in a space between the inner circumferential surface of the rotor hub 241 and an outer circumferential surface of the tubular portion 222. The bearing 212 is arranged to rotatably connect the frame portion 22 and the rotor hub 241 to each other. Thus, once the stator 23 is energized, the rotating portion 24 receives the torque from the stator 23, and rotates about the second central axis J2. The rotating portion 24 is an example of a “second rotating portion” of the present application.

The speed reduction mechanism 25 is arranged radially outside of the rotating portion 24 with respect to the second central axis J2. The speed reduction mechanism 25 is arranged to reduce the speed of a rotational motion obtained from the rotating portion 24, and cause the hollow shaft 21 to rotate at the reduced speed. That is, the speed reduction mechanism 25 is arranged to convert the rotation of the rotating portion 24 to a rotational motion at a rotation rate lower than a rotation rate of the rotating portion 24, and cause the hollow shaft 21 to rotate at the lower rotation rate.

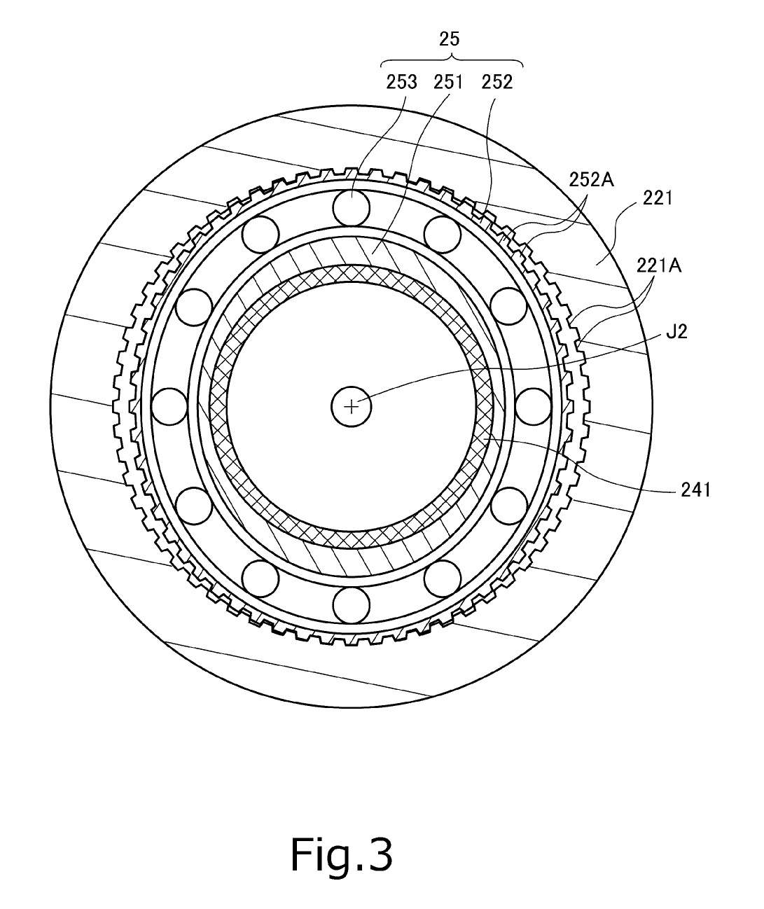

FIG. 3 is a sectional view of the first joint apparatus 101 taken along line III-III in FIG. 2. In FIG. 3, the hollow shaft 21 and so on are not shown.

So-called strain wave gearing, which utilizes a flexible gear, is used as the speed reduction mechanism 25. The speed reduction mechanism 25 includes a cam 251, a flexible external gear 252, and a flexible bearing 253. In the present preferred embodiment, the connection portion 221 of the frame portion 22 forms a component of the speed reduction mechanism 25 as an internal gear.

The cam 251 is an annular member fixed to an outer circumferential surface of the rotor hub 241. The cam 251 is a non-perfect circular cam including an outer circumferential surface having an elliptical shape when viewed along the second central axis J2.

Referring to FIG. 2, the flexible external gear 252 is a flexible tubular portion which is open at a first end and is closed at a second end with respect to the axial direction of the second central axis J2. At the first end, an outer circumferential surface of the flexible external gear 252 includes a plurality of external teeth 252A arranged with a constant pitch in a circumferential direction. The flexible external gear 252 is arranged such that the first end faces toward the frame portion 22. The flexible external gear 252 is fixed to the hollow shaft 21 at the second end. Then, when the flexible external gear 252 rotates about the second central axis J2, the hollow shaft 21 also rotates in a similar manner. The flexible external gear 252 is an example of a “second output portion” of the present application.

The flexible bearing 253 is arranged to intervene between the cam 251 and the flexible external gear 252. An inner race of the flexible bearing 253 is flexible, and is fixed along the elliptical outer circumferential surface of the cam 251. An outer race of the flexible bearing 253 is fixed to an inner circumferential surface of the flexible external gear 252, and is deformed together with the flexible external gear 252. A plurality of balls are arranged to intervene between the inner and outer races of the flexible bearing 253. In an inner circumferential surface of the connection portion 221, a plurality of internal teeth 221A, which are arranged to mesh with the external teeth 252A, are arranged with a constant pitch in the circumferential direction.

When the cam 251 rotates together with the rotor hub 241, the shape of the flexible external gear 252 varies in accordance with the rotation of the cam 251. That is, when viewed along the second central axis J2, the flexible external gear 252 has the shape of an ellipse in accordance with the shape of the outer circumferential surface of the cam 251, and a major axis of the ellipse rotates, following the rotation of the cam 251. Out of the plurality of external teeth 252A defined in the outer circumferential surface of the flexible external gear 252, only those external teeth 252A which are positioned at both ends of the major axis mesh with the internal teeth 221A of the connection portion 221.

In the present preferred embodiment, the number of external teeth 252A and the number of internal teeth 221A are different from each other. Accordingly, every time the cam 251 completes a single rotation, the position of the internal tooth 221A that meshes with the external tooth 252A at the same position in the flexible external gear 252 shifts. Since the frame portion 22 is fixed to the base 105, the internal teeth 221A do not move. Accordingly, the flexible external gear 252 slowly rotates about the second central axis J2. As a result, a rotation rate of the flexible external gear 252 is lower than the rotation rate of the rotating portion 24.

As described above, when the flexible external gear 252 rotates, the hollow shaft 21 also rotates. The hollow shaft 21 is fixed to the cylindrical portion 162 of the holder 16. Therefore, the holder 16 rotates together with the flexible external gear 252 and the hollow shaft 21. The holder 16 is a component of the electric motor 1A, and the electric motor 1A supports the first arm 103. That is, the first joint apparatus 101 uses the electric motor 1B to cause the first arm 103 to rotate about the second central axis J2.

### 2.2. Structure of Electric Motor 1A

The electric motor 1A will now be described below. The electric motor 1A is an example of a “first drive apparatus” of the present application.

The electric motor 1A includes a hollow shaft 11, a frame portion 12, a stator 13, a rotating portion 14, a speed reduction mechanism 15, and the holder 16.

The hollow shaft 11 is a substantially columnar member arranged to extend along the first central axis J1. A substantially columnar fixed shaft 50, which is arranged to extend in an axial direction of the first central axis J1, is inserted into the hollow shaft 11. The hollow shaft 11 includes a key 11A. Once the fixed shaft 50 is inserted into the hollow shaft 11, the key 11A is fitted in a key groove of the fixed shaft 50. As a result, the hollow shaft 11 and the fixed shaft 50 are fixed to each other such that the hollow shaft 11 and the fixed shaft 50 are incapable of relative rotation. That is, when the hollow shaft 11 rotates about the first central axis J1, the fixed shaft 50 also rotates in a similar manner.

The fixed shaft 50 is arranged to have an axial dimension greater than an axial dimension of the hollow shaft 11. Thus, when the fixed shaft 50 has been inserted into the hollow shaft 11, both end portions of the fixed shaft 50 protrude from the hollow shaft 11 in the axial direction. Both the end portions of the fixed shaft 50, which protrude from the hollow shaft 11, are fixed to a holder 60 through a pin 51 and a pin 52, respectively.

The hollow shaft 11 is an example of a “first hollow shaft” of the present application. The key 11A is an example of a “first fastening element” of the present application. Each of the pins 51 and 52 is an example of a “second fastening element” of the present application. The holder 60 is an example of a “second holder” of the present application.

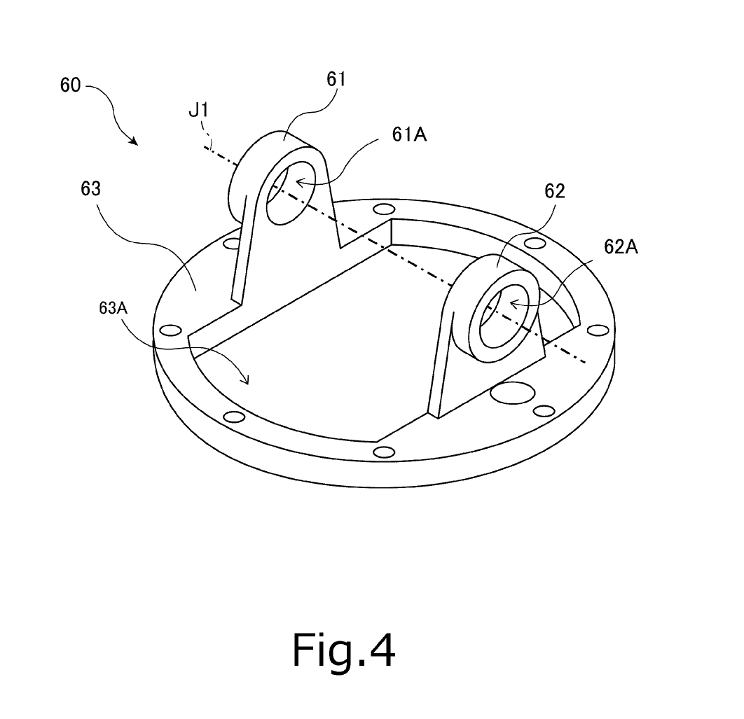

FIG. 4 is a perspective view of the holder 60.

The holder 60 is a holder arranged to connect the electric motor 1A and the first arm 103 to each other. The holder 60 includes a first shaft fixing portion 61, a second shaft fixing portion 62, and a base portion 63. Each of the first and second shaft fixing portions 61 and 62 is arranged to extend perpendicularly from the base portion 63, which is substantially in the shape of a disk. In addition, the first and second shaft fixing portions 61 and 62 are arranged opposite to each other in the axial direction of the first central axis J1 such that the first and second shaft fixing portions 61 and 62 are at such a distance from each other that the electric motor 1A can intervene therebetween.

The first shaft fixing portion 61 includes a first through hole 61A arranged to pass therethrough in the axial direction of the first central axis J1. A first end of the fixed shaft 50, which protrudes from the hollow shaft 11, is inserted into the first through hole 61A. Then, the first shaft fixing portion 61 and the fixed shaft 50 are fixed to each other through the pin 51.

The second shaft fixing portion 62 includes a second through hole 62A arranged to pass therethrough in the axial direction of the first central axis J1. A second end of the fixed shaft 50, which protrudes from the hollow shaft 11, is inserted into the second through hole 62A. Then, the second shaft fixing portion 62 and the fixed shaft 50 are fixed to each other through the pin 52.

The base portion 63 is substantially in the shape of a circular ring. The first arm 103 is fixed to a peripheral portion of the base portion 63 through, for example, bolts. The base portion 63 includes an opening 63A between the first and second shaft fixing portions 61 and 62. The electric motor 1A, which is supported through the fixed shaft 50, is arranged in this opening 63A.

Reference is made again to FIG. 2. The frame portion 12 is arranged radially outside of the hollow shaft 11. The frame portion 12 is in the shape of a circular ring, and is centered on the first central axis J1. The holder 16 is fixed to the frame portion 12 through a connection portion 121, which is arranged at a radially outer end portion of the frame portion 12. In addition, the frame portion 12 includes a tubular portion 122 at a radially inner end portion thereof. The tubular portion 122 is arranged to extend in the axial direction with the first central axis J1 as a center. The tubular portion 122 is arranged to surround the hollow shaft 11 with a space therebetween.

A bearing 111 is arranged in a space between an inner circumferential surface of the tubular portion 122 and an outer circumferential surface of the hollow shaft 11. The bearing 111 is a cross-roller bearing, and is arranged to rotatably connect the hollow shaft 11 and the frame portion 12 to each other. Use of the cross-roller bearing as the bearing 111 allows the hollow shaft 11 and the frame portion 12 to be connected to each other with high strength.

The stator 13 is arranged radially outside of the hollow shaft 11. The stator 13 has a structure similar to that of the stator 23 of the electric motor 1B, and includes a stator core 131 and a plurality of coils 132. Then, the stator 13 is arranged to produce a torque to rotate the rotating portion 14, which will be described below.

The rotating portion 14 is arranged radially outside of the hollow shaft 11. The rotating portion 14 has a structure similar to that of the rotating portion 24 of the electric motor 1B, and includes a rotor hub 141 and a rotor magnet 142. A bearing 112 is arranged in a space between an inner circumferential surface of the rotor hub 141 and an outer circumferential surface of the tubular portion 122. The bearing 112 is arranged to rotatably connect the frame portion 12 and the rotor hub 141 to each other. Then, the rotating portion 14 receives the torque from the stator 13, and rotates about the first central axis J1. The rotating portion 14 is an example of a “first rotating portion” of the present application. The stator 13 forms an example of a “stator unit” of the present application.

The speed reduction mechanism 15 is arranged radially outside of the rotating portion 14. The speed reduction mechanism 15 is arranged to reduce the speed of a rotational motion obtained from the rotating portion 14, and cause the hollow shaft 11 to rotate at the reduced speed. That is, the speed reduction mechanism 15 is arranged to convert the rotation of the rotating portion 14 to a rotational motion at a rotation rate lower than a rotation rate of the rotating portion 14, and cause the hollow shaft 11 to rotate at the lower rotation rate. The speed reduction mechanism 15 includes a cam 151, a flexible external gear 152, and a flexible bearing 153. The speed reduction mechanism 15 has the same structure as that of the speed reduction mechanism 25. That is, when the flexible external gear 152 rotates about the first central axis J1, the hollow shaft 11 also rotates in a similar manner. The flexible external gear 152 is an example of a “first output portion” of the present application. The flexible bearing 153 is an example of a “first bearing” of the present application.

The holder 16 is a member made of a metal, and arranged to couple the electric motors 1A and 1B to each other. The holder 16 is an example of a “first holder” of the present application.

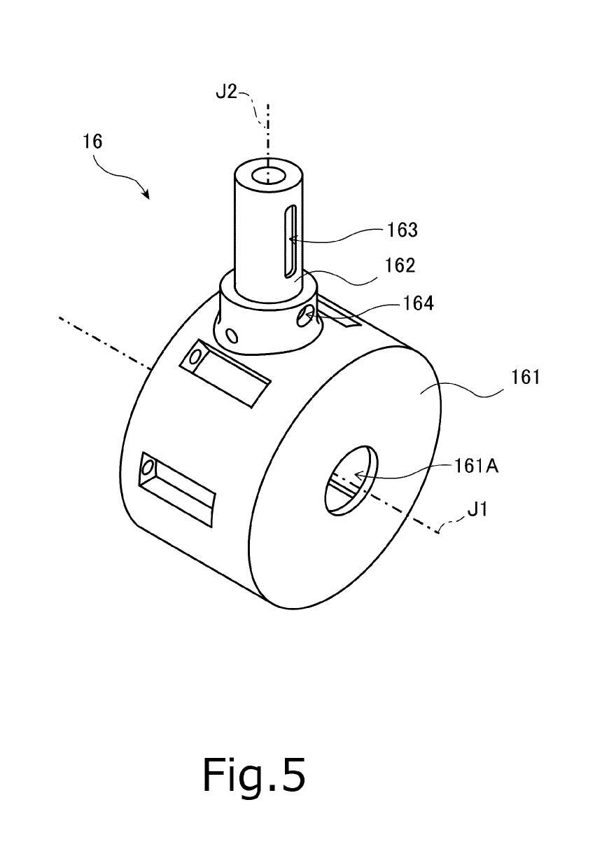

FIG. 5 is a perspective view of the holder 16. The holder 16 includes a casing portion 161 and the cylindrical portion 162.

The casing portion 161 is cylindrical, and is arranged to extend in the axial direction of the first central axis J1. The casing portion 161 is open at a first end and is closed at a second end. The casing portion 161 includes, at the second end, a circular opening 161A centered on the first central axis J1. Referring to FIG. 2, the holder 16 is fixed to the frame portion 12 at the first end, with the first end of the casing portion 161 facing toward the frame portion 12. In addition, the fixed shaft 50 is inserted through the opening 161A at the second end of the holder 16. Further, a bearing 113 is arranged between a wall surface of the opening 161A and an outer circumferential surface of the fixed shaft 50. The bearing 113 is arranged to rotatably connect the fixed shaft 50 and the casing portion 161 to each other.

In this situation, the hollow shaft 11, the stator 13, the rotating portion 14, and the speed reduction mechanism 15 are arranged inside of the casing portion 161. That is, the casing portion 161 defines a casing of the electric motor 1A. The casing portion 161 is an example of a “second support portion” of the present application.

The cylindrical portion 162 is a columnar member arranged to extend in the axial direction with the second central axis J2 as a center. The cylindrical portion 162 is fixed to an outer circumferential surface of the casing portion 161 such that a radial direction with respect to the first central axis J1 coincides with the axial direction of the second central axis J2. The cylindrical portion 162 is inserted into the hollow shaft 21 of the electric motor 1B. As described above, the cylindrical portion 162 includes the key groove 163. Once the cylindrical portion 162 is inserted into the hollow shaft 21, the key 21A of the hollow shaft 21 is fitted in the key groove 163. As a result, the cylindrical portion 162 and the hollow shaft 21 are fixed to each other such that the cylindrical portion 162 and the hollow shaft 21 are incapable of relative rotation.

In addition, the holder 16 includes a wire hole 164 at a junction of the casing portion 161 and the cylindrical portion 162. The wire hole 164 is arranged to pass through a portion of the holder 16 in a radial direction with respect to the second central axis J2. The cylindrical portion 162 has an interior space extending in the axial direction of the second central axis J2. A wire 100A of the robot arm system 100 illustrated in FIG. 1 is arranged to pass through the interior space of the cylindrical portion 162. The wire hole 164 is a hole through which the wire 100A passes between the interior space of the cylindrical portion 162 and a space outside of the cylindrical portion 162. Arranging the wire 100A to pass through the interior space of the cylindrical portion 162 contributes to preventing the wire 100A from being exposed to an outside and from being damaged due to a contact with a moving part. Moreover, arranging a portion of the wire 100A to pass through the interior space of the cylindrical portion 162 contributes to preventing a joint motion from being obstructed by the wire 100A, and preventing a twist at the time of the joint motion.

As described above, when the flexible external gear 152 rotates, the hollow shaft 11 also rotates. The hollow shaft 11 is fixed to the holder 60 through the fixed shaft 50. Therefore, the holder 60 rotates together with the flexible external gear 152, the hollow shaft 11, and the fixed shaft 50. The first arm 103 is fixed to the holder 60. That is, the first joint apparatus 101 uses the electric motor 1A to cause the first arm 103 to rotate about the first central axis J1.

As described above, using the electric motors 1A and 1B, the first joint apparatus 101 enables the first arm 103 to make joint motions about the first central axis J1 and the second central axis J2. The electric motors 1A and 1B, which together enable two-axis joint motions, are arranged in proximity to each other using the holder 16. This contributes to limiting an increase in size of the first joint apparatus 101. Moreover, the proximity of the electric motors 1A and 1B to each other results in a reduction in inertia of the joint motion, which leads to improved responsiveness.

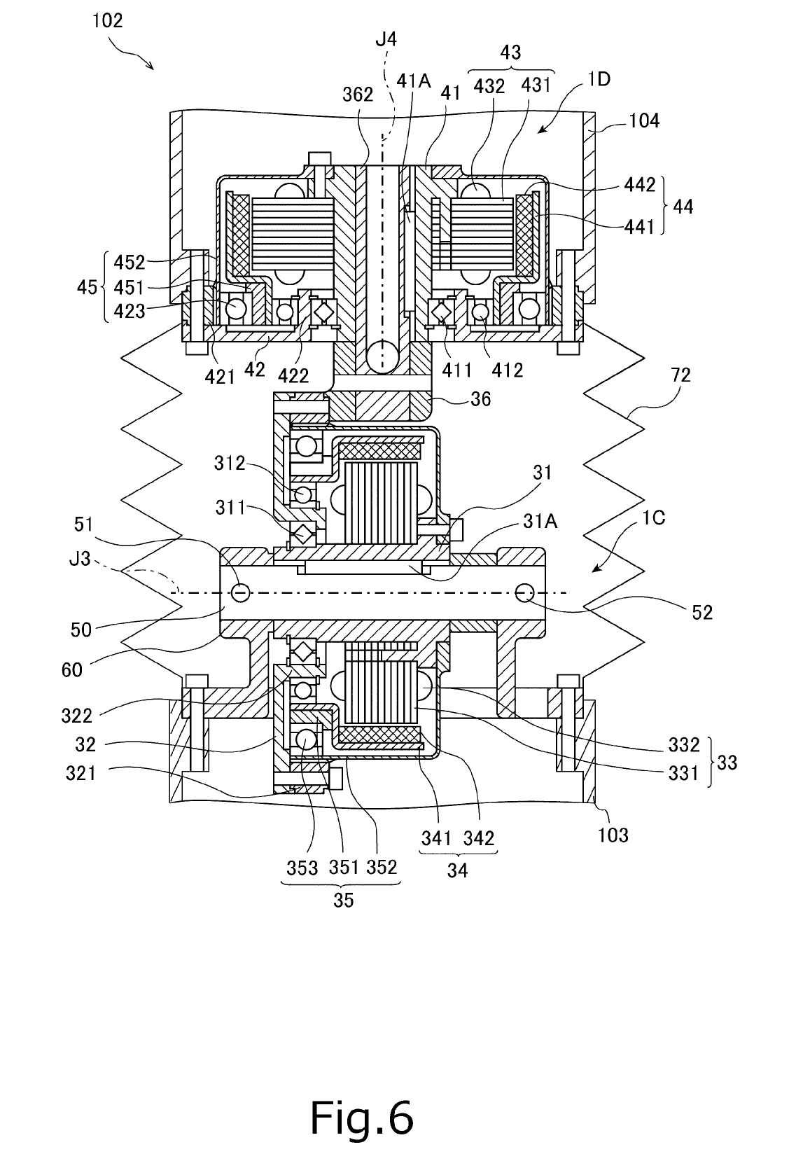

FIG. 6 is a sectional view of the second joint apparatus 102. Note that members of the second joint apparatus 102 which have their equivalents in the first joint apparatus 101 will be denoted by the same reference numerals as those of their equivalents, and redundant description thereof will be omitted.

The second joint apparatus 102 includes the electric motors 1C and 1D. The electric motor 1C is fixed to the first arm 103. The electric motor 1D is arranged to support the second arm 104. In addition, the electric motors 1C and 1D are coupled to each other. A junction of the electric motors 1C and 1D is covered with a bellows cover 72 to protect the junction.

First, the electric motor 1C will now be described below. The electric motor 1C enables the second arm 104 to make a rotational motion about the third central axis J3. The electric motor 1C is an example of the “first drive apparatus” of the present application. The third central axis J3 is an example of a “first central axis” of the present application.

The electric motor 1C includes a hollow shaft 31, a frame portion 32, a stator 33, a rotating portion 34, and a speed reduction mechanism 35.

The hollow shaft 31 is a substantially columnar member arranged to extend along the third central axis J3. A fixed shaft 50 is inserted into the hollow shaft 31. The fixed shaft 50 is fixed to the first arm 103 through a holder 60. The hollow shaft is an example of the “first hollow shaft” of the present application.

The frame portion 32 is arranged radially outside of the hollow shaft 31. The frame portion 32 is in the shape of a circular ring, and is centered on the third central axis J3. A holder 36 is fixed to the frame portion 32 through a connection portion 321, which is arranged at a radially outer end portion of the frame portion 32. In addition, the frame portion 32 includes a tubular portion 322 at a radially inner end portion thereof. The tubular portion 322 is arranged to extend in an axial direction with the third central axis J3 as a center. The tubular portion 322 is arranged to surround the hollow shaft 31 with a space therebetween.

A bearing 311 is arranged in a space between an inner circumferential surface of the tubular portion 322 and an outer circumferential surface of the hollow shaft 31. The bearing 311 is a cross-roller bearing, and is arranged to rotatably connect the hollow shaft 31 and the frame portion 32 to each other. As a result, the frame portion 32 is capable of rotating about the third central axis J3 around the hollow shaft 31. Use of the cross-roller bearing as the bearing 311 allows the hollow shaft 31 and the frame portion 32 to be connected to each other with high strength.

The frame portion 32 is an example of the “first output portion” of the present application. The bearing 311 is an example of a “second bearing” of the present application.

The stator 33 is arranged radially outside of the hollow shaft 31. The stator 33 has a structure similar to those of the stators 13 and 23 of the electric motors 1A and 1B, and includes a stator core 331 and a plurality of coils 332. Then, the stator 33 is arranged to produce a torque to rotate the rotating portion 34, which will be described below.

The rotating portion 34 is arranged radially outside of the hollow shaft 31. The rotating portion 34 has a structure similar to those of the rotating portions 14 and 24 of the electric motors 1A and 1B, and includes a rotor hub 341 and a rotor magnet 342. A bearing 312 is arranged in a space between an inner circumferential surface of the rotor hub 341 and an outer circumferential surface of the tubular portion 322. The bearing 312 is arranged to rotatably connect the frame portion 32 and the rotor hub 341 to each other. Then, the rotating portion 34 receives the torque from the stator 33, and rotates about the third central axis J3. The rotating portion 34 is an example of the “first rotating portion” of the present application. The stator 33 forms an example of the “stator unit” of the present application. The bearing 312 is an example of a “third bearing” of the present application.

The speed reduction mechanism 35 is arranged radially outside of the rotating portion 34. The speed reduction mechanism 35 is arranged to reduce the speed of a rotational motion obtained from the rotating portion 34, and cause the frame portion 32 to rotate at the reduced speed. That is, the speed reduction mechanism 35 is arranged to convert the rotation of the rotating portion 34 to a rotational motion at a rotation rate lower than a rotation rate of the rotating portion 34, and cause the frame portion 32 to rotate at the lower rotation rate. The speed reduction mechanism 35 includes a cam 351, a flexible external gear 352, and a flexible bearing 353. The speed reduction mechanism 35 has substantially the same structure as those of the speed reduction mechanisms 15 and 25, but is different from the speed reduction mechanisms 15 and 25 in that the flexible external gear 352 of the speed reduction mechanism 35 does not rotate.

The flexible external gear 352 includes a plurality of external teeth. The connection portion 321 includes internal teeth arranged to mesh with the external teeth of the flexible external gear 352. Then, meshing of the external teeth of the flexible external gear 352 with the internal teeth of the connection portion 321, and a difference between the number of external teeth of the flexible external gear 352 and the number of internal teeth of the connection portion 321, together cause the flexible external gear 352 and the connection portion 321 to rotate relative to each other. At this time, only the connection portion 321 rotates while the flexible external gear 352 does not rotate. That is, the frame portion 32 rotates about the third central axis J3. A rotation rate of the frame portion 32 at this time is lower than the rotation rate of the rotating portion 34.

When the frame portion 32 rotates about the third central axis J3, the holder 36, which is fixed to the frame portion 32, also rotates in a similar manner. The electric motor 1D is fixed to the holder 36. That is, the second joint apparatus 102 uses the electric motor 1C to cause the electric motor 1D and the second arm 104, which is supported by the electric motor 1D, to rotate about the third central axis J3.

The holder 36 is a member made of a metal, and arranged to couple the electric motors 1C and 1D to each other. The holder 36 is an example of the “first holder” of the present application.

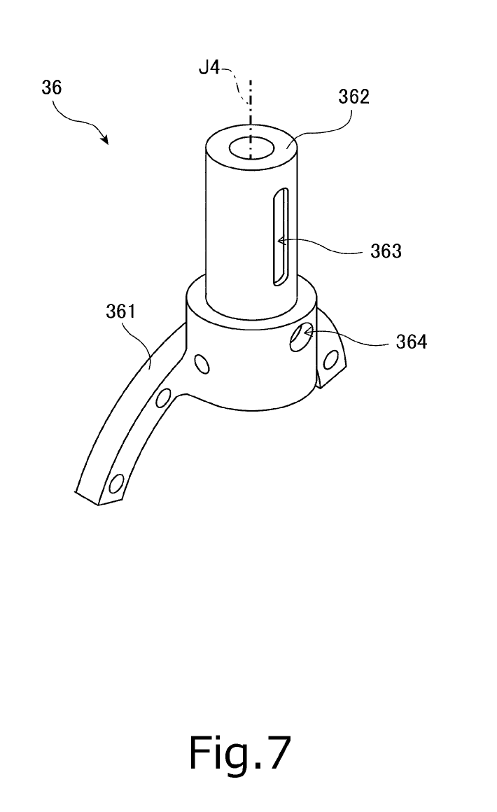

FIG. 7 is a perspective view of the holder 36. The holder 36 includes a support portion 361 and a cylindrical portion 362.

The support portion 361 is an example of a “first support portion” of the present application. The support portion 361 is in the shape of a circular arc. The support portion 361 is fixed along an outer periphery portion of the frame portion 32 in the shape of a circular ring through, for example, bolts. The holder 36 is thus fixed to the frame portion 32.

The cylindrical portion 362 is a columnar member arranged to extend in an axial direction with the fourth central axis J4 as a center. The cylindrical portion 362 is fixed to the support portion 361 such that the axial direction coincides with a radial direction of the support portion 361 in the shape of a circular arc. The cylindrical portion 362 is inserted into a hollow shaft 41 of the electric motor 1D. The cylindrical portion 362 includes a key groove 363. Once the cylindrical portion 362 is inserted into the hollow shaft 41, a key 41A of the hollow shaft 41 illustrated in FIG. 6 is fitted in the key groove 363. As a result, the cylindrical portion 362 and the hollow shaft 41 are fixed to each other such that the cylindrical portion 362 and the hollow shaft 41 are incapable of relative rotation.

In addition, the cylindrical portion 362 includes a wire hole 364 arranged to pass through a portion thereof in a radial direction with respect to the fourth central axis J4. The cylindrical portion 362 has an interior space extending in the axial direction of the fourth central axis J4. The wire 100A of the robot arm system 100 illustrated in FIG. 1 is arranged to pass through the interior space of the cylindrical portion 362. The wire hole 364 is a hole through which the wire 100A passes between the interior space of the cylindrical portion 362 and a space outside of the cylindrical portion 362. Arranging the wire 100A to pass through the interior space of the cylindrical portion 362 contributes to preventing the wire 100A from being exposed to the outside and from being damaged due to a contact with a moving part. Moreover, arranging a portion of the wire 100A to pass through the interior space of the cylindrical portion 362 contributes to preventing a joint motion from being obstructed by the wire 100A, and preventing a twist at the time of the joint motion.

As described above, the holder 36 is fixed to the frame portion 32. The frame portion 32 rotates along with the rotation of the rotating portion 34. The electric motor 1D, which supports the second arm 104, is fixed to the holder 36. That is, the second joint apparatus 102 uses the electric motor 1C to cause the second arm 104 to rotate about the third central axis J3.

The electric motor 1D will now be described below. The electric motor 1D enables the second arm 104 to make a rotational motion about the fourth central axis J4. The electric motor 1D is an example of the “second drive apparatus” of the present application. The fourth central axis J4 is an example of a “second central axis” of the present application.

The electric motor 1D includes the hollow shaft 41, a frame portion 42, a stator 43, a rotating portion 44, and a speed reduction mechanism 45.

The hollow shaft 41 is a substantially columnar member arranged to extend along the fourth central axis J4. The cylindrical portion 362 of the holder 36 is inserted into the hollow shaft 41. Then, as described above, the hollow shaft 41 and the cylindrical portion 362 are fixed to each other through the key 41A and the key groove 363 such that the hollow shaft 41 and the cylindrical portion 362 are incapable of relative rotation.

The hollow shaft 41 is an example of the “second hollow shaft” of the present application. The key 41A is an example of the “third fastening element” of the present application.

The frame portion 42 is arranged radially outside of the hollow shaft 41. The frame portion 42 is in the shape of a circular ring, and is centered on the fourth central axis J4. The second arm 104 is fixed to the frame portion 42 through a connection portion 421, which is arranged at a radially outer end portion of the frame portion 42. In addition, the frame portion 42 includes a tubular portion 422 at a radially inner end portion thereof. The tubular portion 422 is arranged to extend in the axial direction with the fourth central axis J4 as a center. The tubular portion 422 is arranged to surround the hollow shaft 41 with a space therebetween.

A bearing 411 is arranged in a space between an inner circumferential surface of the tubular portion 422 and an outer circumferential surface of the hollow shaft 41. The bearing 411 is a cross-roller bearing, and is arranged to rotatably connect the hollow shaft 41 and the frame portion 42 to each other. As a result, the frame portion 42 is capable of rotating about the fourth central axis J4 around the hollow shaft 41. The frame portion 42 is an example of the “second output portion” of the present application.

The stator 43 is arranged radially outside of the hollow shaft 41. The stator 43 has a structure similar to that of the stator 33, and includes a stator core 431 and a plurality of coils 432. Then, the stator 43 is arranged to produce a torque to rotate the rotating portion 44, which will be described below.

The rotating portion 44 is arranged radially outside of the hollow shaft 41. The rotating portion 44 has a structure similar to that of the rotating portion 34, and includes a rotor hub 441 and a rotor magnet 442. A bearing 412 is arranged in a space between an inner circumferential surface of the rotor hub 441 and an outer circumferential surface of the tubular portion 422. The bearing 412 is arranged to rotatably connect the frame portion 42 and the rotor hub 441 to each other. Then, the rotating portion 44 receives the torque from the stator 43, and rotates about the fourth central axis J4. The rotating portion 44 is an example of the “second rotating portion” of the present application.

The speed reduction mechanism 45 is arranged radially outside of the rotating portion 44. The speed reduction mechanism 45 is arranged to reduce the speed of a rotational motion obtained from the rotating portion 44, and cause the frame portion 42 to rotate at the reduced speed. The speed reduction mechanism 45 includes a cam 451, a flexible external gear 452, and a flexible bearing 423. The speed reduction mechanism 45 has substantially the same structure as that of the speed reduction mechanism 35. Then, similarly to the speed reduction mechanism 35, the speed reduction mechanism 45 is arranged to cause the frame portion 42 to rotate about the fourth central axis J4 at a rotation rate lower than a rotation rate of the rotating portion 44. Along with the rotation of the frame portion 42, the second arm 104, which is fixed to the frame portion 42, also rotates in a similar manner. Thus, the second joint apparatus 102 uses the electric motor 1D to cause the second arm 104 to rotate about the fourth central axis J4.

As described above, using the electric motors 1C and 1C, the second joint apparatus 102 enables the second arm 104 to make joint motions about the third central axis J3 and the fourth central axis J4. The electric motors 1C and 1D, which together enable two-axis joint motions, are arranged in proximity to each other using the holder 36. This contributes to limiting an increase in size of the second joint apparatus 102. Moreover, the proximity of the electric motors 1C and 1D to each other results in a reduction in inertia of the joint motion, which leads to improved responsiveness.

Since the increase in the size of the second joint apparatus 102 can be avoided, the first arm 103, which supports the second joint apparatus 102, does not need to be a high-rigidity member. For example, the first arm 103 may be defined by an aluminum pipe. This will lead to a reduction in weight of the robot arm system 100.

While preferred embodiments of the present invention have been described above, it is to be understood that the present invention is not limited to the above-described preferred embodiments.

For example, although, in the robot arm system 100, the first joint apparatus 101 is fixed to the base 105 while the second joint apparatus 102 is arranged on a side closer to the end effector, a reverse configuration may alternatively be adopted. Specifically, the second joint apparatus 102 may be fixed to the base 105 with the first joint apparatus 101 being arranged on the side closer to the end effector. Also note that the robot arm system 100 may alternatively include only one joint apparatus. In this case, the robot arm system 100 will have two degrees of freedom. Also note that an additional joint apparatus may be connected to the second arm 104 to enable the robot arm system 100 to make joint motions with more than four degrees of freedom.

Also note that, although the keys and the key grooves have been described as examples of fastening elements, knock pins or serrations may alternatively be used as fastening elements.

Each of the members of the first and second joint apparatuses 101 and 102 may be made of, for example, a high-strength metal. However, each of the members may not necessarily be made of a metal, but may alternatively be made of a non-metal material capable of withstanding a load during usage.

Note that the detailed shape of each speed reduction mechanism may be different from the shape thereof as illustrated in the accompanying drawings of the present application. Also note that features of the above-described preferred embodiment and the modifications thereof may be combined appropriately as long as no conflict arises.

Preferred embodiments of the present invention are applicable to, for example, joint apparatuses.

Features of the above-described preferred embodiments and the modifications thereof may be combined appropriately as long as no conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A joint apparatus comprising:
a first drive apparatus including:
a first hollow shaft arranged to extend in a first axial direction with a first central axis as a center to surround the first central axis;
a first rotating portion arranged outside of the first hollow shaft with respect to a first radial direction, and arranged to rotate about the first central axis;
a speed reduction mechanism arranged to reduce a speed of a rotational motion obtained from the first rotating portion;
a first output portion arranged to rotate about the first central axis at a rotation rate resulting from the speed reduction by the speed reduction mechanism; and
a first holder arranged outside of the first hollow shaft with respect to the first radial direction, and including a cylindrical portion arranged to extend outward in the first radial direction; and
a second drive apparatus including:
a second hollow shaft arranged to extend in a second axial direction with a second central axis as a center to surround the second central axis;
a second rotating portion arranged outside of the second hollow shaft with respect to a second radial direction, and arranged to rotate about the second central axis; and
a second output portion arranged to rotate about the second central axis along with rotation of the second rotating portion;
wherein the cylindrical portion of the first holder is fixed to the second hollow shaft.

2. The joint apparatus according to claim 1, wherein the first holder includes a first support portion fixed to the first output portion, and arranged to support the cylindrical portion.

3. The joint apparatus according to claim 1, wherein
the first holder includes a second support portion rotatably connected to the first hollow shaft, and arranged to support the cylindrical portion; and
the second support portion is cylindrical, and is arranged to extend in the first axial direction to surround at least the first hollow shaft, the first rotating portion, and the speed reduction mechanism.

4. The joint apparatus according to claim 1, wherein
the speed reduction mechanism includes:
a non-perfect circular cam arranged to have different diameters at different circumferential positions, and arranged to rotate together with the first rotating portion;
a flexible external gear arranged to be deformed in accordance with rotation of the non-perfect circular cam;
a first bearing being flexible and arranged to intervene between the non-perfect circular cam and the flexible external gear; and
an internal gear arranged outside of the flexible external gear with respect to the first radial direction; and
the flexible external gear and the internal gear are arranged to have different numbers of teeth, mesh with each other, and rotate relative to each other because of the different numbers of teeth.

5. The joint apparatus according to claim 4, wherein
the speed reduction mechanism includes a flexible tubular portion being tubular, being open at one end and closed at another end with respect to a direction along the first central axis, and supported by the first hollow shaft at the other end; and
the flexible external gear is defined in an outer circumferential surface of the flexible tubular portion at the one end.

6. The joint apparatus according to claim 1, wherein
the first drive apparatus includes a stator unit including a plurality of coils arranged in an annular shape with the first central axis as a center; and
the first rotating portion includes a magnet arranged outside of the stator unit with respect to the first radial direction.

7. The joint apparatus according to claim 1, further comprising:
a fixed shaft inserted into the first hollow shaft, and arranged to have an axial dimension greater than an axial dimension of the first hollow shaft; and
a second holder arranged to support the fixed shaft; wherein
the second holder includes a first through hole and a second through hole each of which is arranged to pass through a portion of the second holder in the first axial direction;
the first and second through holes are arranged at a distance from each other and opposite to each other along the first central axis; and
the fixed shaft includes a first end inserted into the first through hole, and a second end inserted into the second through hole, the first and second ends protruding from opposite ends of the first hollow shaft.

8. The joint apparatus according to claim 7, wherein
the fixed shaft is fixed to the first hollow shaft through a first fastening element such that the fixed shaft and the first hollow shaft are incapable of relative rotation; and
the second holder is arranged to fix the fixed shaft through a second fastening element such that the fixed shaft and the second holder are incapable of relative rotation.

9. The joint apparatus according to claim 1, further comprising a wire arranged to pass through an interior space of the cylindrical portion.

10. The joint apparatus according to claim 1, wherein
the first output portion includes a tubular portion arranged outside of the first hollow shaft with respect to the first radial direction, and arranged to extend in the first axial direction to surround the first central axis;
the first rotating portion is arranged radially outside of the tubular portion; and
the joint apparatus further comprises:
a second bearing arranged between the tubular portion and the first hollow shaft to rotatably connect the first output portion and the first hollow shaft to each other; and
a third bearing arranged between the tubular portion and the first rotating portion to rotatably connect the tubular portion and the first rotating portion to each other.

11. The joint apparatus according to claim 10, wherein the second bearing is a cross-roller bearing.

12. The joint apparatus according to claim 1, further comprising a bellows cover arranged to cover a junction of the first and second drive apparatuses.

13. The joint apparatus according to claim 1, wherein the second hollow shaft and the cylindrical portion of the first holder are fixed to each other through a third fastening element such that the second hollow shaft and the cylindrical portion are incapable of relative rotation.

14. The joint apparatus according to claim 1, used in a robot arm system including an arm having multiple degrees of freedom, wherein the arm is fixed to at least one of the first and second output portions.
